(19) United States
(12) Patent Application Publication
(10) Pub. No.: US 2011/0030860 A1
(43) Pub. Date: Feb. 10, 2011

(54) WALLET AND WALLET INSERT

(75) Inventors: Sarah L. Allen, Lehi, UT (US); Cindy J. Allen, Salt Lake City, UT (US)

Correspondence Address: DLC PATENTS, PLLC, 13032 CRATER LAKE CIRCLE, RIVERTON, UT, 84065, US

(73) Assignee: GEM DESIGNS, LLC, Lehi, UT (US)

(21) Appl. No.: 12/850,608

(22) Filed: Aug. 4, 2010

Related U.S. Application Data
(60) Provisional application No. 61/231,221, filed on Aug. 4, 2009.

(51) Int. Cl. A45C 11/18; B31B 1/00

(52) U.S. Cl. 150/147; 493/267

(57) ABSTRACT

One example embodiment includes a wallet insert. The wallet insert includes a first sheet and a second sheet, where the second sheet at least partially covers the first sheet. The wallet insert also includes one or more seal bars, where the one or more seal bars attach the first sheet to the second sheet. The wallet insert further includes one or more pockets, where one or more edges of the one or more pockets are formed by the one or more seal bars.

### CROSS-REFERENCE TO RELATED APPLICATIONS

This application claims the benefit of and priority to U.S. Provisional Patent Application Ser. No. 61/231,221 filed on Aug. 4, 2009, which application is incorporated herein by reference in its entirety.

### BACKGROUND OF THE INVENTION

Wallets have become an important personal item carried by many people every day. Both men and women carry money, pictures, keys, receipts, credit cards and other items valuable in both monetary and personal value in their wallets. Wallets often include inserts with a number of transparent pockets for holding additional items, such as business cards, pictures and credit cards.

Nevertheless, there are a number of problems in current wallet and wallet insert design. For example, wallets often fold to allow the wallet to fit into a more compact space; however, many wallets do not include a mechanism to keep the wallet folded. Instead, the owner of the wallet is expected to keep the wallet in a pocket or purse that provides the necessary force to keep the wallet closed.

Nevertheless, it is becoming increasingly common for women to carry a wallet without a purse. Therefore, these wallets may include a mechanism for remaining closed. One of the more common mechanisms used is a snap or a zipper. Nevertheless, these suffer from a number of drawbacks. In particular, both snaps and zippers wear out over time and become less effective or completely non-functional. In addition, as the wallet gets full the snap may no longer reach to close the wallet or the zipper may have a large amount of strain, causing the zipper to fail. Moreover, snaps and zippers are often sewn onto the outside of the wallet. Over time the strain of closing the wallet can cause snaps and zippers to become detached, thus preventing any closure of the wallet.

Additionally, wallet inserts suffer from a number of drawbacks. The pockets are often sized to accommodate business cards or credit cards. Nevertheless, the pockets are made bigger than the cards to allow the cards to slide freely in and out of the pockets. This necessitates putting the opening along the inside seam, such that when the insert is in the wallet, the cards are prevented from falling out by the inside seam. This, in turn, requires the user to unfold the insert before accessing the cards stored therein. Additionally, as the seams break apart or fail the cards can slide from the pocket. These cards can then be misplaced or lost, causing numerous problems for the user.

Accordingly, there is a need in the art for a wallet that can close without wearing out over time. Additionally, there is need for a wallet insert that can hold cards without relying on the folding of the insert to retain the cards.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a wallet insert. The wallet insert includes a first sheet and a second sheet, where the second sheet at least partially covers the first sheet. The wallet insert also includes one or more seal bars, where the one or more seal bars attach the first sheet to the second sheet. The wallet insert further includes one or more pockets, where one or more edges of the one or more pockets are formed by the one or more seal bars.

Another example embodiment includes a wallet insert. The wallet insert includes a first layer, where the first layer includes a first sheet and a second sheet, where the second sheet at least partially covers the first sheet. The first layer also includes one or more seal bars, where the one or more seal bars attach the first sheet to the second sheet and a pocket, where one or more edges of the pocket are formed by the one or more seal bars and where the pocket includes an opening. The first layer further includes a notch, where the notch is formed in the second sheet near the opening. The wallet insert also includes a back flap attached to the first layer at a seam, where the back flap is attached opposite the opening.

Another example embodiment includes a wallet including one of the forgoing wallet inserts.

Another example embodiment includes a method of manufacturing a wallet insert. The method includes providing a first sheet and a second sheet, where the second sheet at least partially covers the first sheet. The method also includes providing one or more seal bars, where the one or more seal bars attach the first sheet to the second sheet and providing one or more pockets, where one or more edges of the one or more pockets are formed by the one or more seal bars.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates an example of a;

FIG. 2 illustrates an example of a wallet containing a number of creases and pockets;

FIG. 3A illustrates a front view of a folded wallet;

FIG. 3B illustrates a rear view of the wallet of FIG. 3A;

FIG. 4 illustrates an example of a wallet;

FIG. 5 illustrates an example of a wallet insert with a back;

FIG. 6 illustrates an alternative example of a wallet; and

FIG. 7 is a flowchart illustrating a method of manufacturing a wallet insert.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

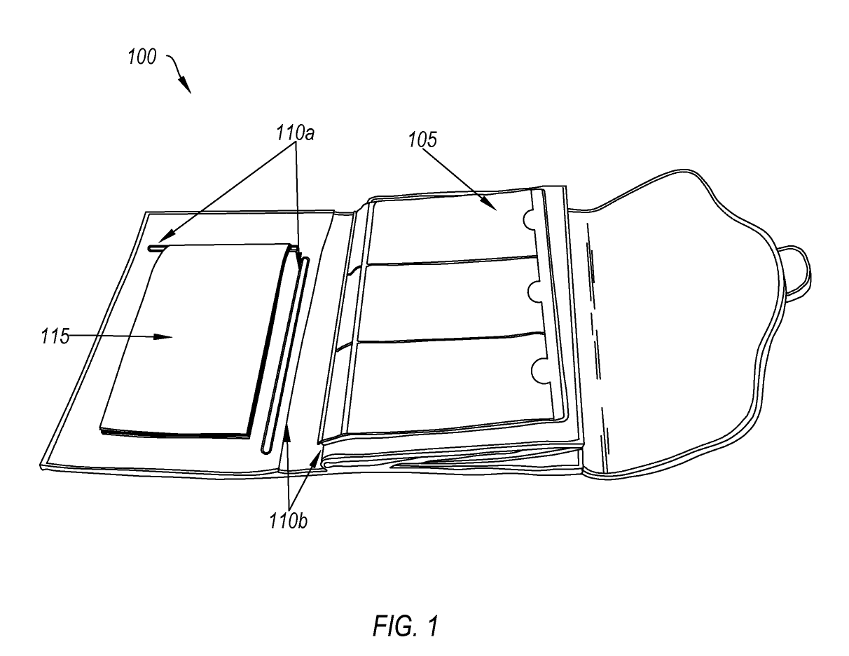

FIG. 1 illustrates an example of a wallet. The wallet 100 can include a small, flat case used to carry personal items. For example, the wallet 100 can be used to carry cash, credit cards, identification documents, such as a driver's license, and numerous other personal possessions. In at least one implementation, the wallet 100 can be made of leather, fabrics or other materials as desired by the user.

The wallet 100 can be sized to fit in the user's pocket. Additionally or alternatively the wallet 100 can be designed to be inserted into purses or other bags, or carried by hand. In at least one implementation, the wallet 100 can be designed to fold in order to occupy a more compact volume and to protect the contents. I.e., the wallet 100 can unfold to allow the user to insert one or more items and can fold to retain the items and protect them from damage.

FIG. 1 shows that the wallet 100 can include an insert 105. In particular, the insert 105 can include one or more pockets to hold personal items. For example, the insert 105 can include pockets that are configured to hold credit cards, business cards, identification cards, pictures, or any other item as desired by the user, as described below.

FIG. 1 also shows that the wallet 100 can include a checkbook pocket 110a. In particular, a checkbook pocket 110a can retain all or part of a checkbook. For example, the checkbook pocket 110a can retain the cardboard backing of a checkbook, such that a user can have access to the checks outside of the checkbook pocket 110a. Additionally or alternatively, the checkbook pocket 110a can retain the entire checkbook, such that a user can remove the checkbook from the checkbook pocket 110a as needed. In at least one implementation, the checkbook pocket 110a can be used to hold anything that is approximately the size of a checkbook. For example, the checkbook pocket can be used to retain notepad 115. FIG. 1 shows that the checkbook pocket 110a can be used for both side tear and top tear checkbooks.

FIG. 1 further shows that the wallet 100 can include one or more insert pockets 110b. The one or more insert pockets 110b can be configured to receive the back flap of the wallet insert 105 to secure the wallet insert 105 within the wallet 100. Additionally or alternatively, the one or more insert pockets can be used to retain items that are too large to fit in other pockets of the wallet 100.

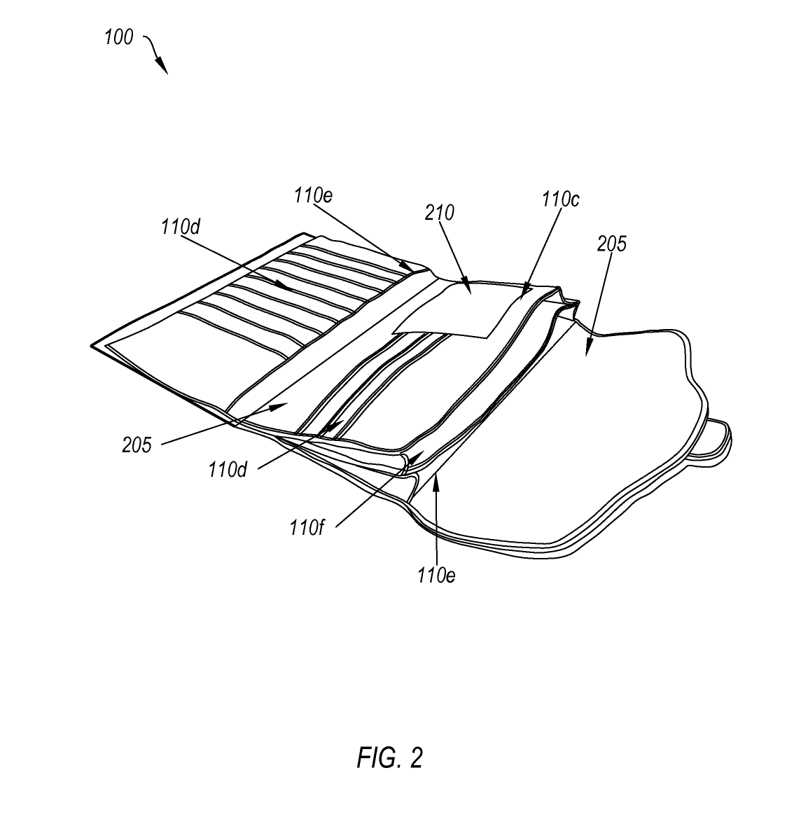

FIG. 2 illustrates an example of a wallet containing a number of creases 205 and pockets 110. FIG. 2 shows that the wallet 100 can include one or more creases 205 that allow the wallet 100 to fold in on itself. In particular, folding the wallet 100 along the one or more creases 205 can allow the wallet 100 to fit within a more compact volume. In at least one implementation, the creases 205 can be located on the opening edge of one or more of the pockets 110 in order to secure the contents of the pockets 110 when the wallet is folded.

FIG. 2 further shows that the wallet 100 can include an identification pocket 110c. In particular, an identification pocket 110c can facilitate the display of a regularly-used piece of identification such as a government issued identification card, a driver's license, a workplace Identification card, a student identification card, a bus pass or any other regularly used piece of identification. Moreover, the identification pocket 110c may include a transparent covering 210. In at least one implementation, the transparent covering 210 can be made of any material which allows the contents of the identification pocket 110c to be viewed without removing the contents from the identification pocket 110c. For example, the transparent cover 210 can be made of transparent plastic or any other suitable transparent material. The transparent cover 210 can cover the entire pocket 110c or can cover only a portion thereof.

FIG. 2 also shows that the wallet 100 can include one or more credit card pockets 110d. In particular, the one or more credit card pockets 110d can be used to hold credit cards, business cards, or any other card of similar size. In at least one implementation, the one or more credit card pockets 110d can be configured to hold multiple cards in each credit card pocket 110d. Additionally or alternatively, the one or more credit card pockets 110d can be configured to hold a single card in each credit card pocket 110d.

FIG. 2 further shows that the wallet 100 can include one or more receipt pockets 110e. In particular, the receipt pockets 110e can store miscellaneous items such as receipts, coupons, notes, keys, coins or any other items that the user may wish to retain within the wallet 100 but which do not have a standard size.

FIG. 2 also shows that the wallet 100 can include a currency pocket 110f. In particular, the currency pocket 110f can be configured to store currency. For example, the currency pocket 110f can be configured to store cash, traveler's checks, money orders or any other currency or currency substitute. In at least one implementation, the currency pocket 110f can be configured to provide ease of access to a user. For example, the currency pocket 110f can be located such that the opening is available to a user when the wallet 100 is partially or completely unfolded.

One of skill in the art will appreciate that although one of the pockets 110 can be sized to fit particular items, the user can place any desired contents in the pockets 110 without restriction. I.e., the size of the pockets 110 or intended use of the pockets 110 should not be seen as limiting the actual use of the wallet 100 unless otherwise indicated in the claims.

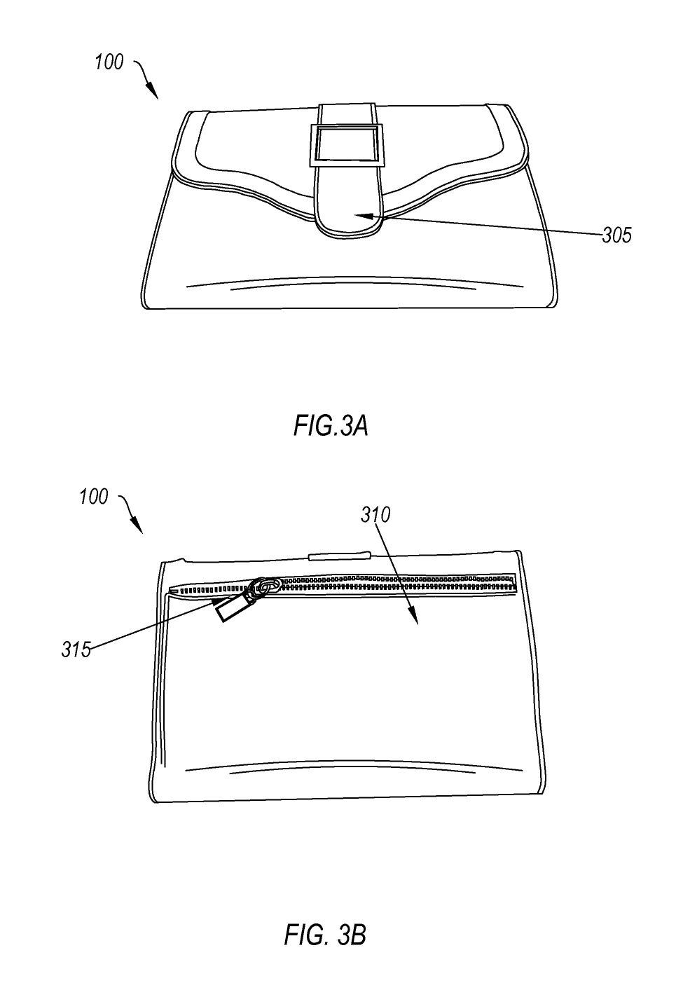

FIGS. 3A and 3B illustrate an example of a folded wallet 100. FIG. 3A illustrates a front view of the wallet 100; and FIG. 3B illustrates a rear view of the wallet 100. In at least one implementation, the wallet 100 can include a bi-fold wallet. I.e., the wallet 100 can fold along a single crease. Additionally or alternatively, the wallet 100 can include a tri-fold wallet. I.e., the wallet 100 can fold along two creases.

FIGS. 3A and 3B show that, in at least one implementation, the wallet 100 can include a clasp 305. In particular, the clasp 305 can prevent the wallet from unfolding until desired by a user. In at least one implementation, the clasp 305 can be magnetic. For example, two magnets that attract one another when in close proximity can form the clasp 305. Additionally or alternatively, a magnet and a ferromagnetic material, such as iron, cobalt or nickel, can form the clasp 305. A clasp 305 that includes a magnet can allow the wallet to remain closed regardless of how full the wallet 100 is. That is, even whether the wallet is full or empty, a magnetic clasp can allow the wallet to close securely. Additionally or alternatively, the clasp 305 can include a snap, a button, a zipper, velcro or any other mechanism which prevents the wallet 100 from unfolding until desired by a user.

FIGS. 3A and 3B also show that the wallet 100 can include an expandable external pocket 310. The external pocket 310 can secure personal items that the user wishes to access without unfolding the wallet 100. For example, the external pocket 310 can be configured to hold keys, cash, coins, a cell phone, important papers or any other item that the user desires to access without unfolding the wallet 100. The external pocket 310 can include a pocket that lays flat or a pocket that includes gussets for expanding when items are placed in the pocket.

FIGS. 3A and 3B further show that the external pocket 310 can be closed using a mechanism, such as a zipper 315. Additionally or alternatively, the external pocket 310 can be closed using a snap, magnets, Velcro, a flap or any other suitable mechanism. In at least one implementation, closing the external pocket 310 can allow a user to secure the contents of the external pocket 310 such that the contents are not accidentally removed.

In at least one implementation, the wallet 100 can include other features as desired by a user. For example, a pen holder can be placed in the wallet 100. A pen holder can include a loop of material through which a pen can be inserted or can include a pocket 110 which is configured to hold a pen. Additionally or alternatively, the wallet 100 can include a detachable strap for carrying the wallet 100. For example, the wallet 100 can include clasps or other attachment mechanisms which allow a strap to be attached to the wallet 100. The strap can be made of the same material as the wallet 100 or can be made from a different material.

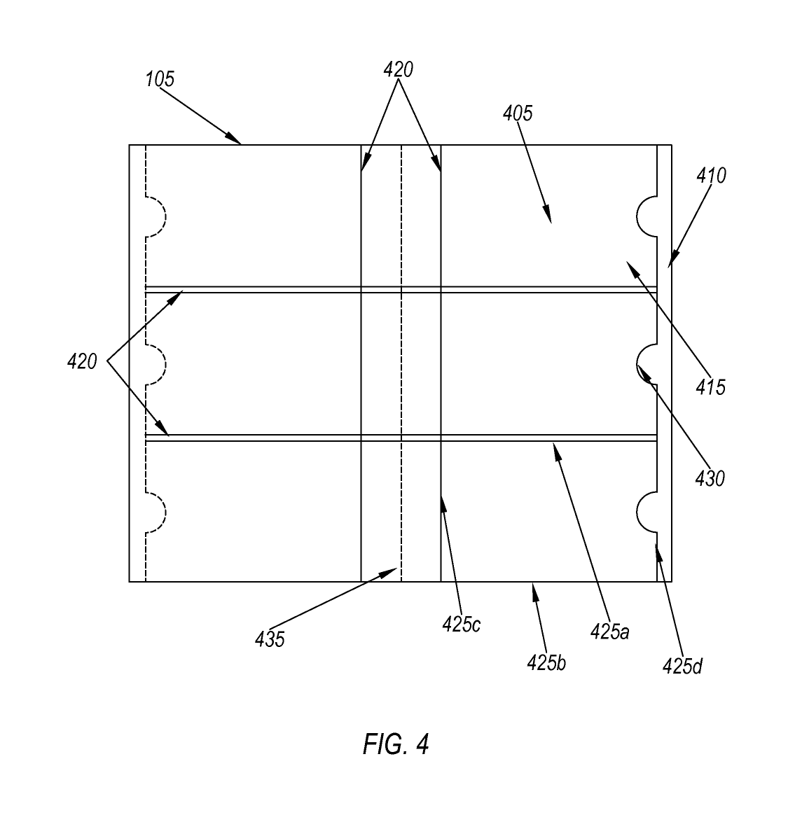

FIG. 4 illustrates an example of a wallet insert 105. In at least one implementation, the insert 105 can be manufactured from any material which can be formed into pockets 405 and which allows the user to insert the desired items into the pockets 405. For example, the insert 105 can be manufactured from plastic, leather, cloth or any other suitable material. Additionally or alternatively, the insert 105 can be manufactured from transparent material so that a user can see the contents of the pockets 405. For example, the wallet insert 105 can be made of transparent plastic. As used in the specification and the claims, the term “plastic” shall include any of a wide range of synthetic or semi-synthetic organic amorphous solids used in the manufacture of industrial products. For example, plastics can thermoplastics and thermosetting polymers.

FIG. 4 shows that the insert 105 can include a layer of pockets 405. I.e., the insert 105 can include one or more pockets 405 that are in the same plane as one another, forming a layer. Each layer of the insert 105 can include one or more pockets 405. For example, each layer can include one, two or three pockets. In at least one implementation, the insert 105 can include more than one layer of pockets 405. For example, the insert 105 can include six layers of pockets 405, eight layers of pockets 405 or any other number of layers.

FIG. 4 shows that the layer of pockets 405 can include a first sheet of material 410. In at least one implementation, the first sheet of material 410 can form one side of the pocket. I.e., the pocket 405 can include two sides formed by three edges with the first sheet of material 410 forming one of the sides. The first sheet of material can include plastic, cloth, leather or any other material suitable for producing a wallet insert.

FIG. 4 also shows that the insert 105 can include a second sheet of material 415 that partially or completely covers the first sheet of material 410. For example, the second sheet of material 415 can be similar in size and shape to the first sheet of material 410. In at least one implementation, the second sheet of material 415 can form the second side of the pockets 405. The second sheet of material 415 can include the same material as the first sheet of material 410 or can include a different material. For example, the first sheet of material 410 and the second sheet of material 415 can both be transparent plastic. Additionally or alternatively, the first sheet of material 410 can include leather and the second sheet of material 415 can include transparent plastic.

FIG. 4 further shows that the first sheet of material 410 and the second sheet of material 415 can connect to one another using one or more seal bars 420. The one or more seal bars 420 can be formed using heat, pressure, heat and pressure or through some other means. The one or more seal bars 420 can be formed along an edge of the first sheet of material 410 or along an edge of the second sheet of material 415. Additionally or alternatively, the one or more seal bars 420 can be formed in the interior of the first sheet of material 410, in the interior of the second sheet of material 415 or both.

FIG. 4 also shows that the one or more seal bars 420 can form one or more pockets 405 within the insert. For example, the seal bars 420 can form a top edge 425a, a bottom edge 425b and an inside edge 425c of the pocket 405. In at least one implementation, an external opening can be formed on the outside edge 425d of the pocket 405 without the presence of a seal bar 420. I.e., the first sheet of material 410 and the second sheet of material 415 can be pressed together to create seal bars 420 that form closed pocket edges 420a, 420b and 420c and the first sheet of material 415 can be left unsealed to the second sheet of material 420 to form an open outside edge 420d.

FIG. 4 further shows that the one or more seal bars 420 can be located to provide the correct number and location of pockets 405. For example, if the wallet insert 105 is configured to include three pockets a first seal bar 420 can be located approximately one third of the way between a first edge and a second edge of the first sheet of material 410 and a second seal bar 420 can be parallel to the first seal bar 420 and can be located approximately two thirds of the way between the first edge and the second edge of the first sheet of material 410. A third seal bar 420 can be perpendicular to the first seal bar 420 and the second seal bar 420 to provide an inside edge 420c of the pocket 405.

Additionally or alternatively, if the wallet insert 105 is configured to include two pockets a first seal bar 420 can be located approximately one half of the way between a first edge and a second edge of the first sheet of material 410. A second seal bar 420 can be perpendicular to the first seal bar 420 to provide an inside edge 420c of the pocket 405.

Additionally or alternatively, the insert 105 can include a third sheet of material that partially or completely covers the first sheet of material 410. In at least one implementation, the third sheet of material can be placed opposite the second sheet of material 415, such that the first sheet of material 410 and the third sheet of material can form an additional level of pockets. I.e., the first sheet of material 410 can be sandwiched between the second sheet of material 415 and the third sheet of material to form pockets 405 on both sides of the first sheet of material 410.

FIG. 4 also shows that the opening of the pockets 405 on the left of FIG. 4 face opposite the opening of the pockets 405 on the right of FIG. 4. That is, the open outside edge 420d of the pockets 405 on the left are under the first sheet of material 410 and open outside edge 420d of the pockets 405 on the right are above the first sheet of material 410.

FIG. 4 further shows that the pockets 405 can be configured to contain credit cards or identification cards that are sized according to the ISO/IEC 7810 standard for 10-1 sized cards. The ISO/IEC 7810 standard is an international standard that defines the physical characteristics for identity or identification cards. The 10-1 format of the ISO/IEC 7810 standard specifies a size of 85.60×53.98 mm (3.370×2.125 in). The 10-1 format can be used for banking cards (ATM cards, credit cards, debit cards, etc.) for driver's licenses, personal identity cards, business cards, the United States passport card and any other type of identification card.

In at least one implementation, the pocket 405 can be configured such that an 10-1 format sized card can be retained within the pocket 405 without closing or otherwise securing the opening of the pocket 405. For example, the pocket 405 can be 3⅝ inches (3.625 inches) wide and 2¼ inches (2.25 inches) long. A pocket 405 that is 3⅝ inches by 2¼ inches can retain an 10-1 sized card using frictional forces between the first sheet of material 410, the second sheet of material 415 and the card.

FIG. 4 also shows that the second sheet of material 410 can include a notch 430 on the outside edge 425d of the pocket 405. The notch 430 can be configured to allow a user access to the card stored in the pocket 405 without lessening the frictional forces used to retain the card. For example, the notch 430 can be a semi-circle with a ⅝ inch (0.625 inch) diameter, allowing a user to easily grasp the card for removal without significantly lessening the frictional forces.

FIG. 4 further shows that the insert 105 can include a seam 435 for allowing the insert to be folded. In particular, the seam 435 can allow an insert with multiple layers of pockets 405 to be manufactured and used and thus can allow a user to store multiple cards in a compact volume. In at least one implementation, the distance between the seam 435 and the inside edge 420c can be between ⅜ (0.325) and ¾ (0.75) of an inch. For example the gap can be ½ (0.5) inch or can be ⅝ (0.625) inch. This gap can allow the wallet insert 105 to lie flat within a wallet.

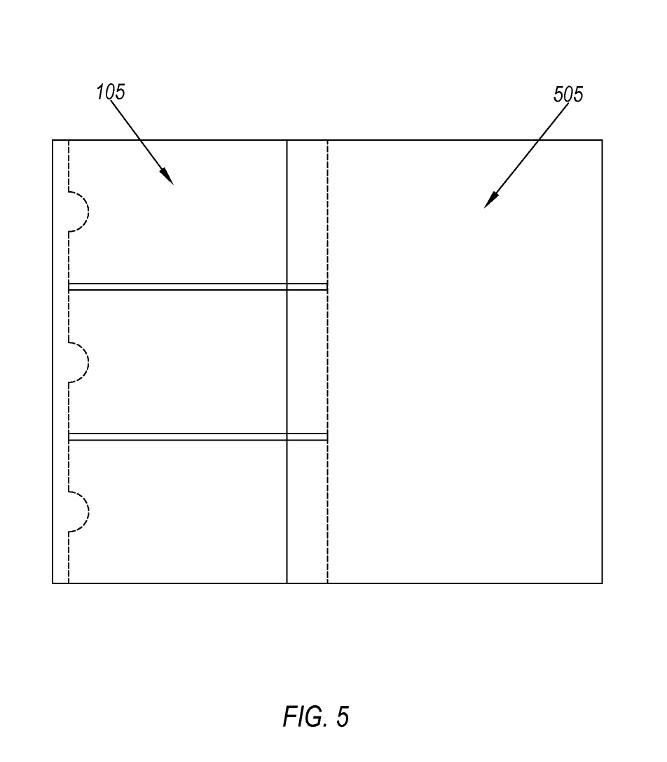

FIG. 5 illustrates an example of a wallet insert 105 with a back flap. In at least one implementation, the back flap 505 can be inserted into a pocket within a wallet, such as a pocket 110 in the wallet 100 of FIG. 1. In particular, the back flap can secure the insert 105 within a wallet to prevent the insert 105 from being removed until desired by a user.

Additionally or alternatively, the wallet insert 105 can include a second back flap. A second back flap 505 can allow the user to place the back flaps in multiple pockets within a wallet. Accordingly, the wallet insert 105 can be held within the wallet more securely. Alternatively, a second back flap can serve as a cover for the insert 105, protecting the cards within the pockets of the insert 105 from wear.

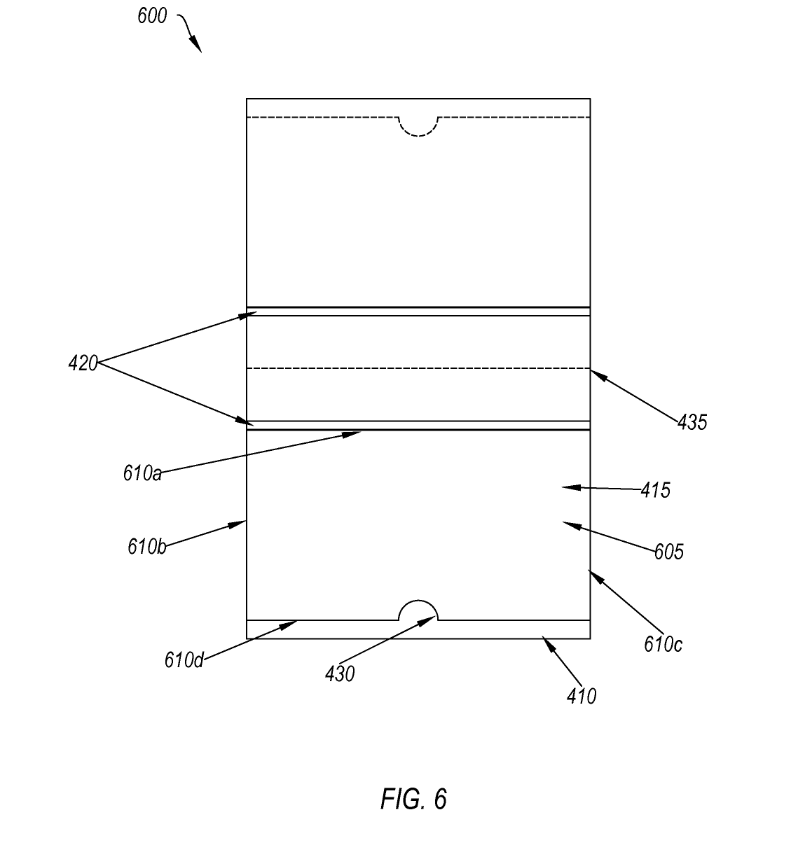

FIG. 6 illustrates an alternative example of a wallet insert 600. FIG. 6 shows that the wallet insert 600 is similar to the wallet insert 105 of FIGS. 1, 4 and 5. Nevertheless, FIG. 6 shows that the wallet insert 105 includes pockets 605 that are oriented in a different manner than the wallet insert 105 of FIGS. 1, 4 and 5.

FIG. 6 shows that the insert 600 can be manufactured from any material which can be formed into pockets 605 and which allows the user to insert the desired items into the pockets 605. For example, the insert 600 can be manufactured from plastic, leather, cloth or any other suitable material. Additionally or alternatively, the insert 600 can be manufactured from transparent material so that a user can see the contents of the pockets 605. For example, the wallet insert can be made of transparent plastic.

FIG. 6 shows that the insert 600 can include a first sheet of material 410. FIG. 6 also shows that, in at least one implementation, the insert 600 can include a second sheet of material 415 that partially or completely covers the first sheet of material 410. FIG. 6 further shows that, in at least one implementation, the first sheet of material 410 and the second sheet of material 415 can connect to one another using one or more seal bars 420. The one or more seal bars 420 can be formed using heat, pressure, heat and pressure or through some other means.

Moreover, FIG. 6 shows that, in at least one implementation, the one or more seal bars 420 can form one or more pockets 605 within the insert. For example, the seal bars 420 can for an inside edge 610a, a left edge 610b and a right edge 610c of the pocket 605. In at least one implementation, an external opening can be formed on the outside edge of 610d of the pocket 605 without the presence of the seal bar 420.

FIG. 6 also shows that, in at least one implementation, the opening of the pockets 605 on the top of FIG. 6 face opposite the opening of the pockets 605 on the bottom of FIG. 6. That is, the notches 430 and opening of the pockets 605 on the top are under the first sheet of material 410 and the notches 430 and opening of the pocket 605 on the bottom are above the first sheet of material 410.

FIG. 6 shows that, in at least one implementation, the pockets 605 can be configured to contain credit cards or identification cards that are sized according to the ISO/IEC 7810 standard for 10-1 sized cards. In particular, the pocket 605 can be configured such that an 10-1 format sized card can be retained within the pocket 605 without otherwise securing the opening of the pocket 605. For example, the pocket 605 can be 3½ inches (3.5 inches) wide and 2⅜ inches (2.375 inches) tall. A pocket 605 that is 3½ inches by 2⅜ inches can retain an 10-1 sized card using frictional forces between the first sheet of material 410, the second sheet of material 415 and the card.

FIG. 6 also shows that, in at least one implementation, the second sheet of material 410 can include a notch 430 on the outside edge 605d of the pocket 605. The notch 430 can be configured to allow a user access to the card stored in the pocket 605 without lessening the frictional forces used to retain the card. For example, the notch 430 can be a semi-circle with a ⅝ inch (0.625 inch) diameter, allowing a user to easily grasp the card for removal without significantly lessening the frictional forces.

FIG. 6 further shows that, in at least one implementation, the insert 600 can include a seam 435 for allowing the insert to be folded. In particular, the seam 435 can allow an insert with multiple layers of pockets 605 to be manufactured and can thus allow a user to store multiple cards in a compact volume.

In at least one implementation, the insert 600 can include a back flap. In particular, the back flap can be inserted into a pocket within a wallet, such as a pocket 205 in the wallet 100 of FIG. 1. In particular, the back flap can secure the insert 600 within a wallet to prevent the insert 600 from being removed until desired by a user.

Additionally or alternatively, the wallet insert 600 can include a second back flap. A second back flap can allow the user to place the back flaps in multiple pockets within a wallet. Accordingly, the wallet insert 600 can be held within the wallet more securely. Alternatively, a second back flap can serve as a cover for the insert 105, protecting the cards within the pockets of the insert 600 from wear.

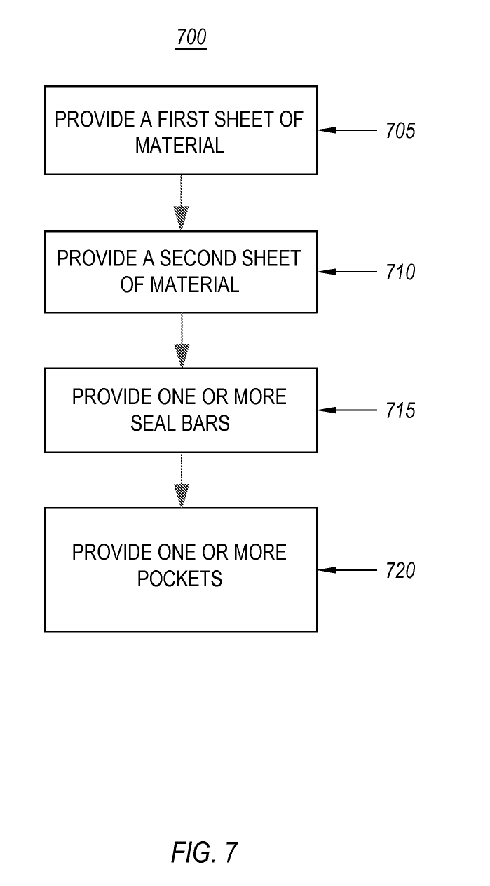

FIG. 7 is a flowchart illustrating a method 700 of manufacturing a wallet insert. One of skill in the art will appreciate that the method 700 can be used to produce the insert 105 of FIG. 1 or the insert 600 of FIG. 6; however, the method 700 can be used to produce wallet inserts other than the insert 105 of FIG. 1 or the insert 600 of FIG. 6.

In at least one implementation, the insert can be manufactured from any material which can be formed into pockets and which allows the user to insert the desired items into the pockets. For example, the insert can be manufactured from plastic, leather, cloth or any other suitable material. Additionally or alternatively, the insert can be manufactured from transparent material so that a user can see the contents of the pockets. For example, the wallet insert can be made of transparent plastic.

FIG. 7 shows that the method 700 includes providing a first sheet of material 705. In at least one implementation, the first sheet of material can form one side of the wallet insert. The first sheet of material can include plastic, cloth, leather or any other material suitable for producing a wallet insert. For example, the wallet insert can be made of transparent plastic.

FIG. 7 also shows that the method 700 can include providing a second sheet of material 710 that partially or completely covers the first sheet of material. For example, the second sheet of material can be similar in size and shape to the first sheet of material. The second sheet of material can include the same material as the first sheet of material or can include a different material. For example, the first sheet of material and the second sheet of material can both be transparent plastic. Additionally or alternatively, the first sheet of material can include leather and the second sheet of material can include transparent plastic.

FIG. 7 further shows that the method 700 can include providing one or more seal bars 715. The one or more seal bars can connect the first sheet of material and the second sheet of material. The one or more seal bars can be formed using heat, pressure, heat and pressure or through some other means. The one or more seal bars can be formed along an edge of the first sheet of material or along an edge of the second sheet of material. Additionally or alternatively, the one or more seal bars can be formed in the interior of the first sheet of material, in the interior of the second sheet of material or both.

FIG. 7 also shows that the method 700 can include providing one or more pockets 720. In at least one implementation, the one or more seal bars can form the one or more pockets of the insert. For example, the seal bars can form a top edge, a bottom edge and an inside edge of the pocket. In at least one implementation, an external opening can be formed on the outside edge of the pocket without the presence of a seal bar. I.e., the first sheet of material and the second sheet of material can be pressed together to create seal bars that form closed pocket edges and the first sheet of material can be left unsealed to the second sheet of material to form an open outside edge.

In at least one implementation, the pockets can be configured to contain credit cards or identification cards that are sized according to the ISO/IEC 7810 standard for 10-1 sized cards. The ISO/IEC 7810 standard is an international standard that defines the physical characteristics for identity or identification cards. The 10-1 format of the ISO/IEC 7810 standard specifies a size of 85.60×53.98 mm (3.370×2.125 in). The 10-1 format can be used for banking cards (ATM cards, credit cards, debit cards, etc.) for driver's licenses, personal identity cards, business cards, the United States passport card and any other type of identification card.

In at least one implementation, the pocket can be configured such that an 10-1 format sized card can be retained within the pocket without closing or otherwise securing the opening of the pocket. For example, the pocket can be 3⅝ inches (3.625 inches) wide and 2¼ inches (2.25 inches) long. A pocket that is 3⅝ inches by 2¼ inches can retain an 10-1 sized card using frictional forces between the first sheet of material, the second sheet of material and the card.

In at least one implementation, the second sheet of material can include a notch on the outside edge of the pocket. The notch can be configured to allow a user access to the card stored in the pocket without lessening the frictional forces used to retain the card. For example, the notch can be a semi-circle with a ⅝ inch (0.625 inch) diameter, allowing a user to easily grasp the card for removal without significantly lessening the frictional forces.

In at least one implementation, the insert can include a seam for allowing the insert to be folded. In particular, the seam can allow an insert with multiple layers of pockets to be manufactured and used and thus can allow a user to store multiple cards in a compact volume. In at least one implementation, the distance between the seam and the inside edge can be between ⅜ (0.325) and ¾ (0.75) of an inch. For example the gap can be ½ (0.5) inch or can be ⅝ (0.625) inch. This gap can allow the wallet insert to lie flat within a wallet.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A wallet insert, the wallet insert comprising:
a first sheet;
a second sheet, wherein the second sheet at least partially covers the first sheet;
one or more seal bars, wherein the one or more seal bars attach the first sheet to the second sheet; and
one or more pockets, wherein one or more edges of the one or more pockets are formed by the one or more seal bars.

2. The wallet insert of claim 1, further comprising two pockets.

3. The wallet insert of claim 1, further comprising three pockets.

4. The wallet insert of claim 3, wherein the one or more seal bars further include:
a first seal bar, wherein the first seal bar is located approximately one third of the distance between a first edge of the first sheet and a second edge of the first sheet;
a second seal bar, wherein the second seal bar is parallel to the first seal bar and located approximately two thirds of the distance between the first edge of the first sheet and the second edge of the first sheet.

5. The wallet insert of claim 4, wherein the one or more seal bars further include:
a third seal bar, wherein the third seal bar is perpendicular to the first seal bar and the second seal bar.

6. The wallet insert of claim 1, wherein the one or more seal bars further include:
a first seal bar along a first edge of the first sheet.

7. The wallet insert of claim 1, further comprising a notch in the second sheet, wherein the notch is located on an open edge of the one or more pockets.

8. The wallet insert of claim 7, wherein the notch includes a semi-circle with a radius of 0.625 inches.

9. A wallet insert, wherein the wallet insert comprises:
a first layer, wherein the first layer includes:
a first sheet and a second sheet, wherein the second sheet at least partially covers the first sheet;
one or more seal bars, wherein the one or more seal bars attach the first sheet to the second sheet;
a pocket, wherein one or more edges of the pocket are formed by the one or more seal bars and wherein the pocket includes an opening; and
a notch, wherein the notch is formed in the second sheet near the opening; and
a back flap attached to the first layer at a seam, wherein the seam is opposite the opening.

10. A wallet, wherein the wallet includes the wallet insert of claim 9.

11. The wallet of claim 10, wherein the wallet includes a magnetic clasp.

12. The wallet insert of claim 9, wherein the distance between the one or more pockets and the seam is between 0.325 and 0.75 inches.

13. The wallet insert of claim 12, wherein the distance between the one or more pockets and the seam is approximately 0.5 inches.

14. The wallet insert of claim 9, further comprising:
a second layer including:
a third sheet and a fourth sheet, wherein the fourth sheet at least partially covers the second sheet;
one or more seal bars, wherein the one or more seal bars attach the third sheet to the fourth sheet;
a pocket, wherein one or more edges of the pocket are formed by the one or more seal bars and wherein the pocket includes an opening; and
a notch, wherein the notch is formed in the second sheet near the opening; and
wherein the second layer is attached to the first layer and the back flap at the seam.

15. A method of manufacturing a wallet insert, the method comprising:
providing a first sheet;
providing a second sheet, wherein the second sheet at least partially covers the first sheet;
providing one or more seal bars, wherein the one or more seal bars attach the first sheet to the second sheet; and
providing one or more pockets, wherein one or more edges of the one or more pockets are formed by the one or more seal bars.

16. The method of claim 15, wherein the method further comprises:
pressing the first sheet and the second sheet together to form the one or more seal bars.

17. The method of claim 16, wherein the method further comprises:
heating the first sheet and the second sheet while pressing together the first sheet and the second sheet to form the one or more seal bars.

18. The method of claim 15, wherein the first sheet and the second sheet include transparent plastic.

19. The method of claim 15, wherein the one or more pockets are between 3.5 and 3.75 inches wide and 2.125 and 2.375 inches long.

20. The method of claim 19, wherein the one or more pockets are approximately 3.625 inches wide and 2.25 inches long.
